(19) United States
(12) Patent Application Publication
(10) Pub. No.: US 2010/0195872 A1
(43) Pub. Date: Aug. 5, 2010

(54) SYSTEM AND METHOD FOR IDENTIFYING OBJECTS IN AN IMAGE USING POSITIONAL INFORMATION

(75) Inventors: Carmelo Velardo, Bagnara Calabra (IT); David Kryze, Campbell, CA (US); Luca Rigazio, San Jose, CA (US); Philippe Morin, Goleta, CA (US); Peter Veprek, San Jose, CA (US)

Correspondence Address: GREGORY A. STOBBS, 5445 CORPORATE DRIVE, SUITE 400, TROY, MI, 48098, US

(73) Assignee: PANASONIC CORPORATION, OSAKA (JP)

(21) Appl. No.: 12/678,262

(22) PCT Filed: Sep. 18, 2008
(86) PCT No.: PCT/US08/76873

§ 371 Date: Mar. 15, 2010

Related U.S. Application Data
(60) Provisional application No. 60/973,532, filed on Sep. 19, 2007.

(51) Int. Cl. G06K 9/00; G06K 9/46

(52) U.S. Cl. 382/106; 382/190; 348/E05.031

(57) ABSTRACT

A computer-implemented method is provided for identifying objects in an image. The method includes: capturing a series of images of a scene using a camera; receiving a topographical map for the scene that defines distances between objects in the scene; determining distances between objects in the scene from a given image; approximating identities of objects in the given image by comparing the distances between objects as determined from the given image in relation to the distances between objects from the map. The identities of objects can be re-estimated using features of the objects extracted from the other images.

### FIELD

The present disclosure relates generally to a system and method for identifying objects in an image using features extracted from the image in combination with positional information learned independently from the image.

### BACKGROUND

Image recognition is becoming more and more sophisticated. Nonetheless, image recognition suffers from certain deficiencies. Consider a system based on face recognition, identification using this technique requires a database fixed a priori for its work. Such a system also requires that all the features be visible in the captured image to allow for proper detection and recognition. Two people facing a camera can be easily detected and recognized by the system based on facial features, but there is no possibility of identifying a person facing away from the camera. Thus, a system employing only image recognition cannot alone ensure positive identification of all the persons captured in an image.

This section provides background information related to the present disclosure which is not necessarily prior art.

### SUMMARY

A computer-implemented method is provided for identifying objects in an image. The method includes: capturing an image using a camera; generating a map that defines a spatial arrangement between objects found proximate to the camera and provides a unique identifier for each object in the map; detecting objects in the image using feature extraction methods; and identifying the objects detected in the image using the map.

In another aspect of the disclosure, the method for identifying object includes: capturing a series of images of a scene using a camera; receiving a topographical map for the scene that defines distances between objects in the scene; determining distances between objects in the scene from a given image; approximating identities of objects in the given image by comparing the distances between objects as determined from the given image in relation to the distances between objects from the map. The identities of objects can be re-estimated using features of the objects extracted from the other images.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 depicts an exemplary scene captured by a camera;

FIGS. 2A and 2B depict two exemplary map realizations which illustrate the rotation and flipping uncertainty;

FIG. 3 is a high level block diagram of the method for identifying objects in accordance with the present disclosure;

FIG. 4 is a block diagram of an exemplary feature extraction process;

FIGS. 5A-5D illustrate different types of features that may be used in a Haar classifier;

FIG. 6 is a block diagram depicting the initialization phase of the methodology;

FIG. 7 illustrates the relationship between the focal length and the angle of view for an exemplary camera;

FIG. 8 depicts how the field of view for the camera is transposed onto a corresponding topographical map;

FIGS. 9A-9D depict distance conversion functions for an exemplary camera at different focal lengths;

FIG. 10 is a block diagram depicting the expectation maximization algorithm of the methodology.

The drawings described herein are for illustrative purposes only of selected embodiments and not all possible implementations, and are not intended to limit the scope of the present disclosure.

### DETAILED DESCRIPTION

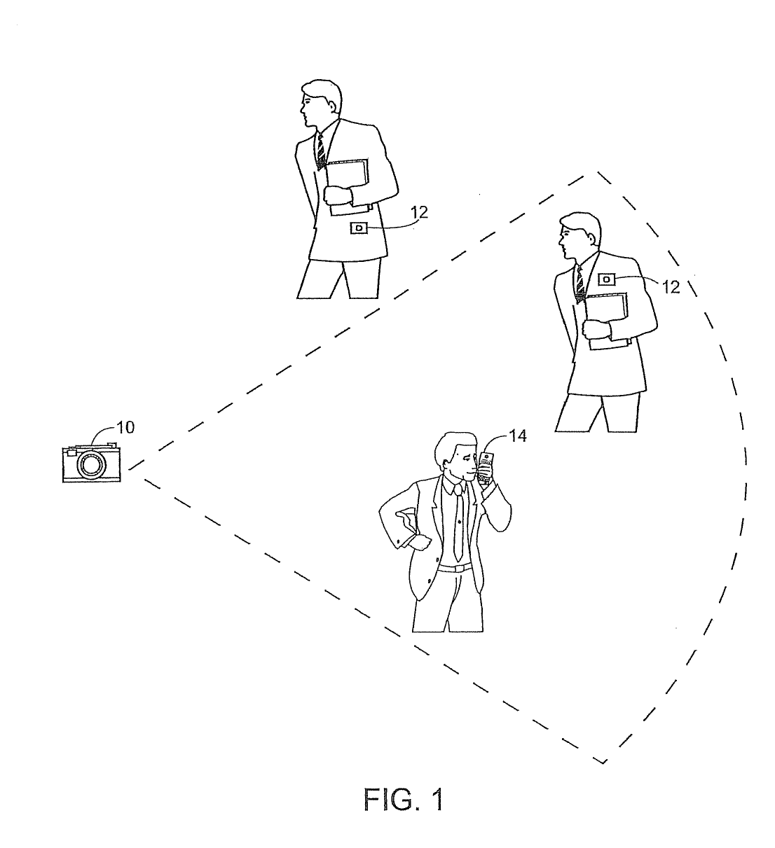

FIG. 1 depicts an exemplary scene in which an image may be captured by a camera 10, a camcorder or another type of imaging device. The camera will make use of positional information for the persons or objects proximate to the camera. The positional information, along with a unique identifier, for each person may be captured by the camera in real-time while the image is being taken by the camera. It is noted that the camera captures positional information not only for the persons in the field of view of the camera but rather all of the persons in the scene. Exemplary techniques for capturing positional information from objects proximate to the camera are further described below.

Methods and algorithms residing in the camera combine the positional information for the persons to determine which persons are in the image captured by the camera. Image data may then be tagged with the identity of persons and their position in the image. Since the metadata is automatically collected at the time an image is captured, this technology can dramatically transform the way we edit and view videos or access image contents once stored. In addition, knowing what is in a scene and where it is in the scene enables interactive services such as in-scene product placement or search and retrieval of particular subjects in a media flow.

To identify objects in an image, the system will use a topographical map of objects located proximate to the camera. In an exemplary embodiment, persons wear location-aware tags 12 or carry portable devices 14, such as cellphones, which contain a tag therein. Each tag is in wireless data communication with the camera 10 to determine distance measures therebetween. The distance measures are in turn converted to a topographical map of objects which may be used by the camera. Distance measures between the tags and the camera may be computed using various measurement techniques.

An exemplary distance measurement system is the Cricket indoor location system developed at MIT and commercially available from Crossbow Technologies. The Cricket system uses a combination of radio frequency (RF) and ultrasound technologies to provide location information to a camera. Each tag includes a beacon. The beacon periodically transmits an RF advertisement concurrent with an ultrasonic pulse. The camera is configured with one or more listeners. Listeners listen for RF signals, and upon receipt of the first few bits, listen for the corresponding ultrasonic pulse. When this pulse arrives, the listener obtains a distance estimate for the corresponding beacon by taking advantage of the difference in propagation speeds between RF (speed of light) and ultrasound (speed of sound). The listener runs algorithms that correlate RF and ultrasound samples (the latter are simple pulses with no data encoded on them) and pick the best correlation. Other measurement techniques and technologies (e.g., GPS) are contemplated by this disclosure. In any case, the output from this process is a fully connected graph, where each node represents a person or an object (including the camera) that is proximate to the camera and each edge indicates the distance between the objects.

Converting the graph into a topographical map can involve some special considerations which are further discussed below. The creation of the map depends on computing ranging measurements between node pairs. These measurements are affected by errors. In order to obtain a good approximation of the map, we had a look to many methods

To fix these problems there exist suboptimal solutions based on minimization of the errors on the map computation. Almost all those solutions are iterative, although some of them are based on distributed version of certain algorithms. For our first tests, we built a simple triangulation system for computing a map starting from a given distance matrix. Even though this solution was fairly good, at the end we opted for the solution of Moore, more fast and accurate. Although this solution is very reliable we could not fix the problems due to the normal use. Using ultrasound pulses is an accurate method to estimate a distance but both the sender and the receiver must face each other. If this does not happen the ranging measurement is not guaranteed.

Converting a distance matrix into Euclidean coordinates information is a challenging result. The approximation of the map, computed starting from the distance matrix, leads to a solution that is correct only in its own coordinate system. Once the map is computed, for the purpose of our algorithm, we would like to match the map with its real world position and keep this match during the time.

Unfortunately, this is not possible because of the lack of anchors in the real world. In fact, all the algorithms concerning mapping techniques we examined, were based on some anchors, that is to say nodes with a fixed position in the real world which does not change during the time, and then during the computation of the map. Having those references with the real world makes the work of matching the relative map (the one computed) with the real one (the one in the real world) a trivial problem. Unfortunately, in our scenarios, all the nodes can move at the same time, we cannot count on this information. And since the distance computation is sampling the reality, we cannot be sure that the map will maintain its characteristics during the time.

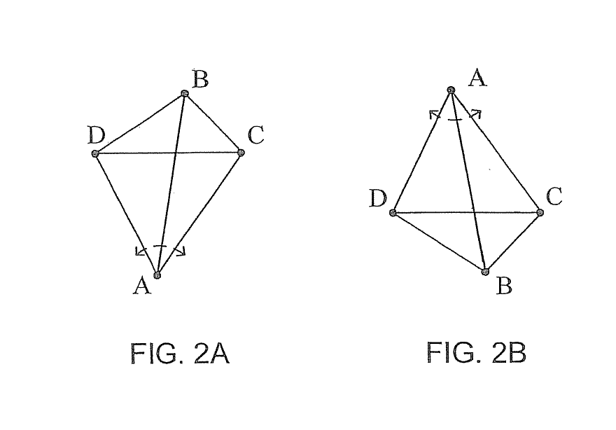

This gives rise to two problems: a rotation uncertainty and a flipping uncertainty as shown in FIG. 2. The first is very easy to understand, since every node does not know its orientation with the others, each rotated version of the map is correct for that node. The second issue rose when we have to place nodes in our map, such a decision cannot account on fixed locations and it is up to the algorithm placing a localized nodes. One can easily see that this problem raises only with the first three nodes; they are the ones that decide the cartesian axis for the map. Each representation of the rotated map and the flipped one are coherent with the distances computed, this means that each representation is correct. Obviously, the lack of fixed reference points in the real world do not help in finding an absolute position of the relative map.

The graph theory shares a lot of localization problems. The problem of finding Euclidean coordinates of a set of vertices of a graph is known as the graph realization problem. The algorithm presented works as a robust distributed extension of a basic quardrilateration. In addition to this, the ranging measurements are dynamically filtered by using Kalman filter.

Each node computes a local map taking into account only three neighbors creating with them a robust quad. A quad is the smallest subgraph that can be computed without certainty of flipping. In addition, a quad is said robust when the following can be applied to all the four triangles created for decomposition of the quad: b=sin² θ>dₘᵢₙ, where b is the shortest side of each triangle and θ is the smallest angle. The dₘᵢₙ value being a constant to bound the probability error. This computation is thought as a solution to the glitching of points due to bad measurements. If θ goes to zero, this will cause the possibility of having a glitch in the position of a point, that is to say the behavior will be the same as having a bad measurement.

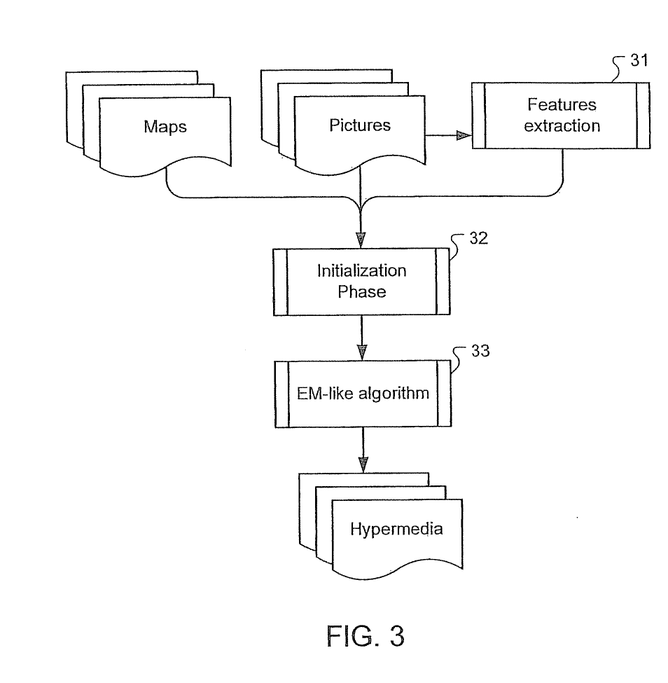

Once a single node has quad information, it can start the local map computation. The local map considers only the four nodes belonging to that quad. Coordinates are computed locally and the center of the system is the node that is performing the mapping (i.e., the camera). After this computation is finished, every single node shares information with the neighbors and with the network. The quad system allows us to combine two different robust quads that share three points into a map of five points that maintains the robustness by definition. This computation also requires a conversion of coordinates of all the local maps into the current one. At the end, we will obtain several versions (all equals) of the same map, but each version is based on a different system of coordinates that as center of the cartesian axis have the current node as shown in FIG. 3.

Even though this algorithm is more robust version of the initial design, and even if it is faster than any other method that uses multi-dimensional scaling, it still shares the same problems due to lack of fixed references. This lead to representations of the same map that can be easily flipped and rotated without losing the correctness of the ranging measurements. The problem of finding the correct orientation for a node (and then solve the flipping issue) is an intermediate step of our algorithm. In fact, the problem of knowing who (or what) is inside the scene can be reduced in finding the correct orientation and flipping status of the camera with the current map.

In an alternative embodiment, the camera may receive a topographical map from an existing infrastructure residing at the scene location. For example, a room may be configured with a radar system, a sonar system or other type of location tracking system that generates a topographical map for the area under surveillance. The topographical map can then be communicated to the camera.

FIG. 3 illustrates a high level view of the algorithm used to identify objects in an image. The algorithm is comprised of three primary sub-components: feature extraction 31, initialization 32, and expectation maximization 33. Each of these sub-components of the algorithm is further described below. It is to be understood that only the relevant steps of the algorithm are discussed below, but that other software-implemented instructions may be needed to control and manage the overall operation of the camera. In addition, the algorithm may be implemented as computer executable instructions in a computer readable medium residing on the camera or another computing device associated with the camera.

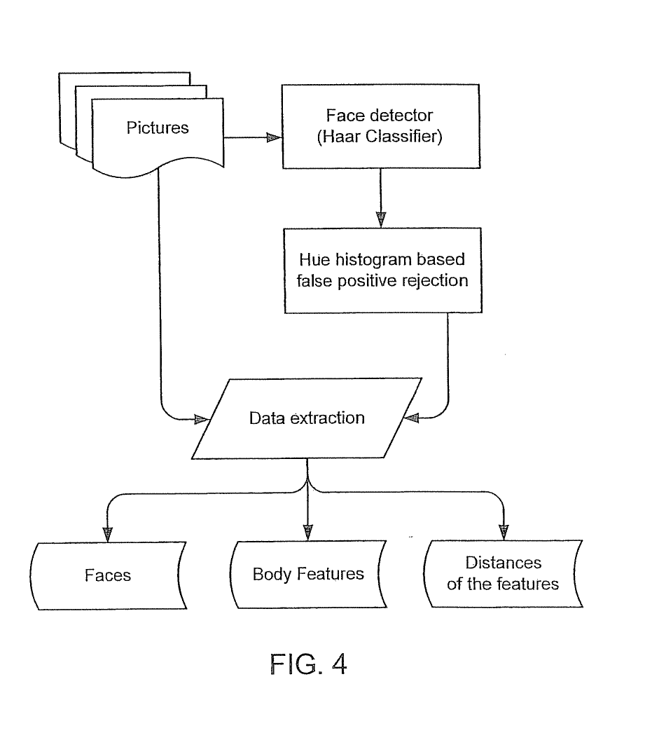

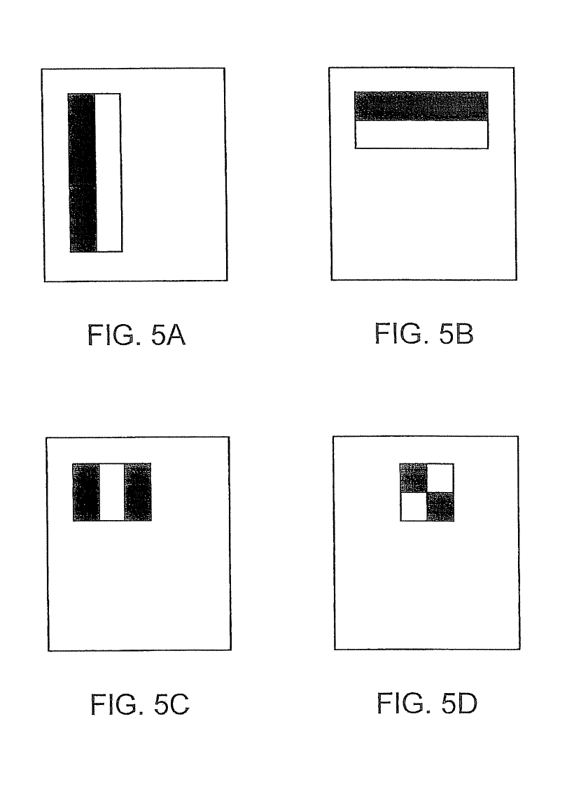

Feature extraction methods are first applied to each image as shown in more detail in FIG. 4. The aim of feature extraction is to detect where objects are in an image and compute the distances between these objects as derived from the image data. This operation only relies upon information provided by the pictures. In an exemplary embodiment, feature extraction is implemented using a Haar classifier as further described below. Other types of detection schemes are also contemplated by this disclosure.

A Haar classifier is a machine learning technique for fast image processing and visual object detection. A Haar classifier used for face detection is based mainly on three important concepts: the integral image, a learning algorithm and a method for combining classifiers in a cascade. The main concept is very simple, a classifier is trained with both positive and negative examples of the object of interest; after the training phase, such a classifier can be applied to a region of interest (of the same size as used during the training) in an input image. The classifier outputs a binary result for a given image. Positive result means that an object was found in the region of interest; a negative output means that the area is not likely to contain the target.

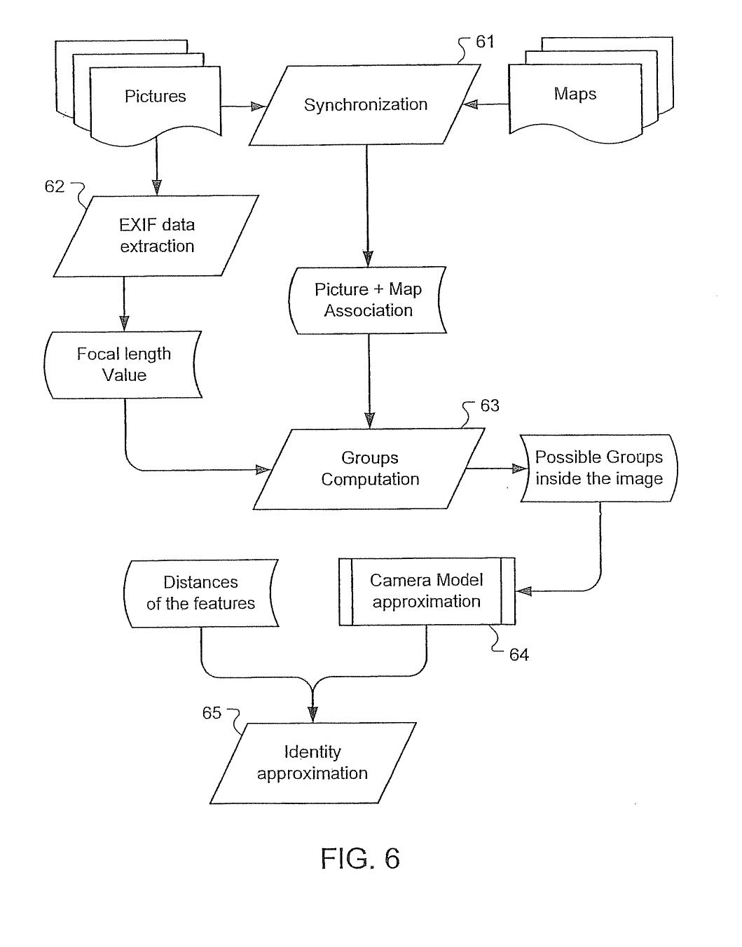

The method is based on features computed on the image. The classifier uses very simple features that look like the Haar basis functions. The features computed with the Haar detector are of three different kinds and they consist of a number of rectangles that are used for some computations. In an exemplary implementation, the features used are similar to the ones represented in FIG. 6. These features are based on simple operations (sum and subtraction) of different adjacent regions of the image. These computations are done for different sizes of these rectangles.

To improve the performance, the concept of integral image is introduced. An integral image has the same size of the original image but for each location (i, j) it has the sum of all the values of the pixels above and to the left of that position. We can write

$$II ( i , j ) = {\sum }_{{i}^{′} \leq i , {j}^{′} \leq j} I ( {i}^{′} , {j}^{′} )$$

where II(i, j) is the integral image and I(i, j) is the original image. By introducing the cumulative row sum s(i, j)

s(i,j)={s(i,j−1)+I(i,j)|s(i,−1)=0}

II(i,j)={II(i−1,j)+s(i,j)|II(−1,j)=0}

it is easy to verify that the integral image can be computed fast and linearly with the dimension of the image. This new concept speeds up the computation of the sum and subtraction of the Haar like features extracted from the image. This new kind of operator makes it possible to compute, for a given image, the features at all the scales needed, without losing time in computationally expensive processes.

The number of features within any image subwindow is far larger than the number of pixels. In order to speed up the process of the detection, most of these features are excluded. This is achieved with a modification of the learning machine algorithm (AdaBoost) in order to take in consideration only the features that at that step gives the best results. Each step of the classifier is based only on one small feature, by combining all the results from all the features in cascade one with the other, we will obtain a better classifier.

The whole detector is made of a cascade of little, simple and weak classifiers. Each classifier hₗ(x) is composed by a feature fₗ(x), a threshold θₗ and a parity pₗ which indicate the direction of the feature: x indicates a sub area of the image (for the case of OpenCV is a square of 24×24 pixels).

$${h}_{l} ( x ) = \{ \begin{matrix}1 & if {p}_{l} {f}_{l} ( x ) < {p}_{l} {θ}_{l} \\ 0 & otherwise\end{matrix} \qquad$$

In practice it is impossible for a single feature to obtain a low error rate, however, the error rate of an early classifier is lower than one of the latest. At each stage of the cascade, if a classifier returns a negative value, the subarea is rejected, if the next stage is not triggered and so on.

Each classifier is built using the modified AdaBoost algorithm, a machine learning algorithm that speeds up the learning process. To search for the object in the image once can move the search window across the pixels and check every location using the classifier, this is designed so that it can be easily resized in order to be able to find the objects of interest at different sizes, which is more efficient than resizing the image itself. So, to find an object of an unknown size in the image the scan procedure should be done several times at different scales.

Colors can also be exploited as essential information for face detection. According to the results obtained by using color information for the detection of faces, we devised a simple method for the false positive rejection. To solve the problem that affected our detector, we created a false positives rejecter based on the computation of correlation between the histogram of the extracted subimages and on a priori computed histogram.

A color histogram is a flexible construct whose purpose is to describe image information in a specific color space. A histogram of an image is produced by discretization of the colors in an image into a number of bins. Then by counting the number of image pixels in each bin. Let I be an n×n image (for simplicity we assume and image as a square), the colors of I are quantized in m colors c₁, c₂, c₃, . . . , cₘ. For a pixel p=(x,y)εI, let C(p) denote its color, then I_{c}={p|C(p)=c}. Hence, the notation pεI_{c} means pεI,C(p)=c. A histogram of an image I is defined as follows: for a color cᵢ, iε[m]

H_{ci}(I)=∥I_{ci}∥

and then as the number of pixels of color cᵢ in I.

A scale invariant version of the histogram is then defined:

$${h}_{ci} ( I ) = P [ p ∈ {I}_{ci} ] = \frac{{H}_{ci} ( I )}{{n}^{2}}$$

Besides being an invariant version of a color histogram, the equation above describes the probability that randomly picking any pixel p from the image I, the probability that the color of p is cᵢ is h_{ci} (i.e. h_{ci} is a probability distribution of the colors in the image).

The histogram is easily computed in O(n²) time, which is linear in the size of I. Despite some authors preference to define histograms only as counts H and then dependent on the image size, for our purposes we needed a computation that should be suitable for varying-sized images and then we preferred the normalized version.

By using the Harris classifier as detector, we built a big database divided into two labeled data sets: faces, non-faces. The cumulated histogram for all the faces (respectively non-faces) is computed and then normalized. For taking advantage of all the channels at once, the Hue value of the pixels is used which led to illumination invariance. The values for the histograms were not quantized. The motivation of HUE range for being [0°, 180°] is due to OpenCV that use only that range for the HUE values that usually are in the range [0°, 360°].

Considering that a face extracted is for the most part composed by skin colored regions, it is not surprising that the highest density regions for the face histogram are the ones near 0° and 180° (red). Since it is really difficult to create a model for a non-face, we chose images coming from a lot of different databases (mainly images of possible backgrounds) and in addition to the false positives coming from the face detection phase, we repeated the computations done before.

For each image detected using the Haar classifier, we extract the related normalized HUE histogram and we compute the correlation with both the histograms for the faces and for the non-faces. Knowing that the faces histogram is the only one based on trustworthy data, we gave higher importance to this one by giving two different weights to the correlation thresholding. This method accomplished its purpose by rejecting a high number of false positives.

A face is good information that reveals the presence of a person. Nevertheless, we are going to see that a system based on facial features is not preferred for our purposes. For simplifying the dissimilarity computation between features and in order to solve the problem of people not facing the camera, we decided to base our computations on clothes samples. Subimages for clothes are easily extracted from the image since we already have the information of the face location in the picture.

In order to compute dissimilarity between clothes samples, we explored the possibility of using histograms and autoacorrelograms. We are going to introduce the Correlogram, a feature used in content-based image retrieval. The computation of such a feature is quite similar to the one used for the histogram but more robust. The correlogram concept was born to solve the issues brought by the histograms; it takes into account the correlation between all the pairs of colors for a given distance.

For a set of distances dε[n] fixed a priori we define the color correlogram of I as:

γ_{ci,cj}^{(k)}(I)=Pr└p₂εI_{cj},|p₁−p₂|=k|p₁εI_{ci}|

Therefore, the correlegram of an image is a table indexed by color pairs and distances, where the k-th element of the <i, j> entry is the probability of finding a pixel of color j at a distance of k from a pixel of color i. The size of such a feature is O(m²d) (for the image I we make the same assumption as for the histogram definition).

The definition of the autocorrelogram follows easily. If we consider only the same colors pairs then we will obtain the autocorrelogram as

a_{c}^{(k)}(I)={γ_{ci,cj}^{(k)}(I)|i=j}

this last feature is a subset of the correlogram and its size is O(md). This feature takes into account the correlation of the pairs of colors inside the image becoming a spatial description of the distribution of the color of an image. It goes then beyond the histogram which shows only the distribution of the colors in an image loosing the information about their positions inside the photo. The only drawback of such a feature is the time for its computation, but since the size of the subimages we considered is small this lead to a not expensive duty for our algorithm.

In the exemplary embodiment, color of clothes samples were chosen as the features of interest because they are easier to manage than faces and do not involve computational expensive dissimilarity operations. However, the system was devised to work more generally with every kind of feature one can imagine extracting from a picture and this makes the algorithm as general purpose as possible. For example, we envision an application that detects objects which are not persons in an image. In this case, an object detector may be trained with an object signature of the specific target. It is also envisioned that the object signature is stored in the location aware tag and sent to the camera when the picture is taken.

Initialization phase is further described in relation to FIG. 6. The initialization phase begins to identify the objects in the image by determining possible groups of objects that could fall within the field of view of the camera; and, for each possible group of objects, comparing distances between objects in the group as determined from the image with distances between objects taken from the map. In some instances, this may be sufficient to identify the objects in an image.

Since image collection and map generation are independent processes, each image must be synchronized with a corresponding topographical map as a first step 61. To account for movement of objects between images, a topographical map may be acquired concurrently with each image that is captured by the camera. When neither the objects nor the camera is moved between images, it may be possible link a single topographical map to a series of images.

Synchronization is based on information provided from the pictures and the maps. In the exemplary embodiment, images captured by a digital camera include exchangeable image file format (EXIF) information. The EXIF information is extracted from all the pictures at 62 saving them one by one, for doing so we create a small bash shell script. The script extracts the date and the time the picture was taken and the focal length size when the picture was taken. The image is synched with a corresponding map using the data and time associated with the image and a similar timestamp associated with the map.

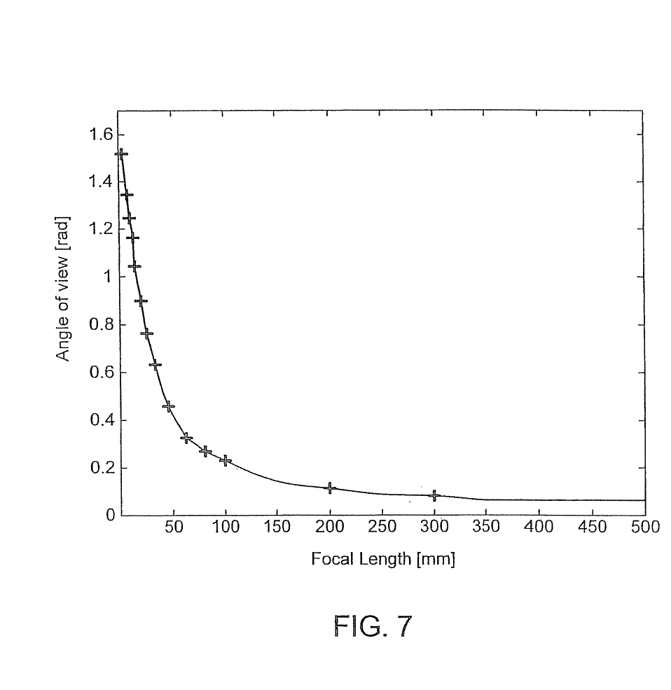

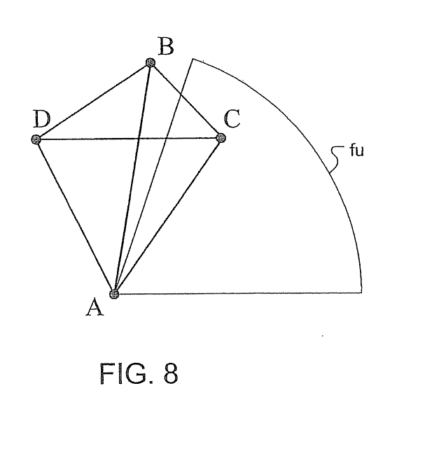

Given a topographical map for an image, possible groups of objects that could fall within the field of view of the camera are enumerated at step 63. A horizontal angle of view is first derived from the focal length value extracted from the EXIF file. For a given camera, an equation that converts the focal length (in millimeters) to angle of view (in radiants) is empirically derived. FIG. 7 depicts the function for a Canon EOS Digital Rebel camera. The angle of view in turn translates to a field of view at which the image was captured by the camera.

Upon computing the field of view, determination of the possible groups can begin. With reference to FIG. 7, the field of view (fv) for an image is transposed onto the corresponding topographical map such that its origin aligns with the camera. In this figure, the camera is signified by node A. The field of view is then rotated at different increments in relation to the map. Each position indicates a possible group of object that could fall within the field of view of the camera. The n-th group of a photo Pᵢ is indicated as g_{i,n}. There is no distinction between a flipped and an original version in the notation since the two cases are automatically managed by the algorithm as distinct cases.

Identity of objects in an image can be approximated at 65 by comparing the distances between objects in a given group as determined from the image with distances between objects taken from the map. This comparison is made for each possible group of objects.

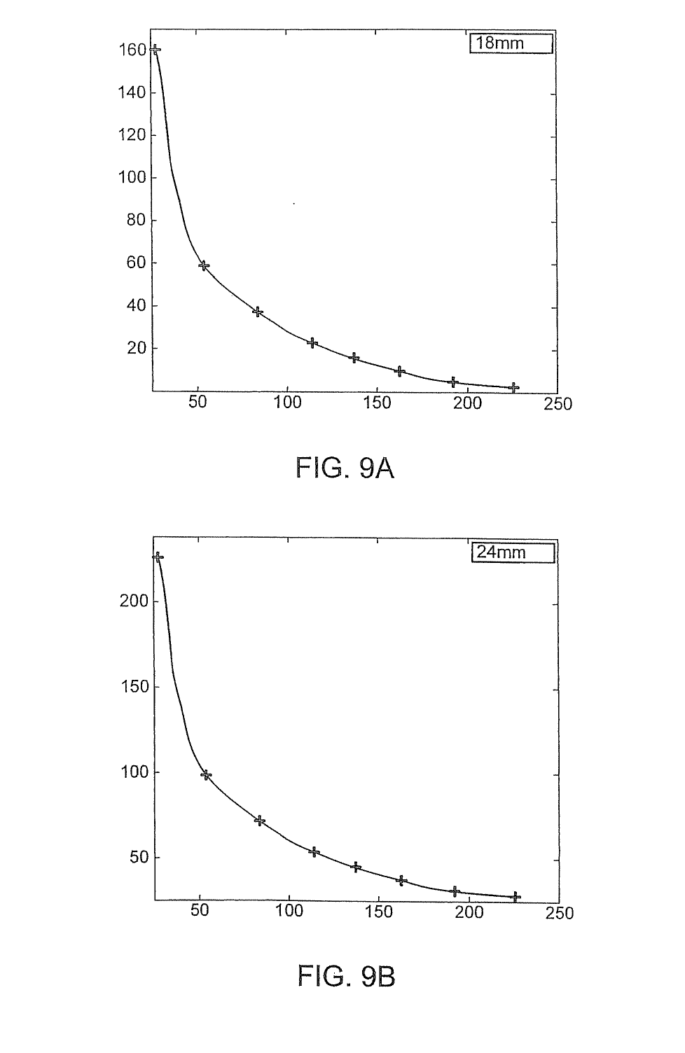

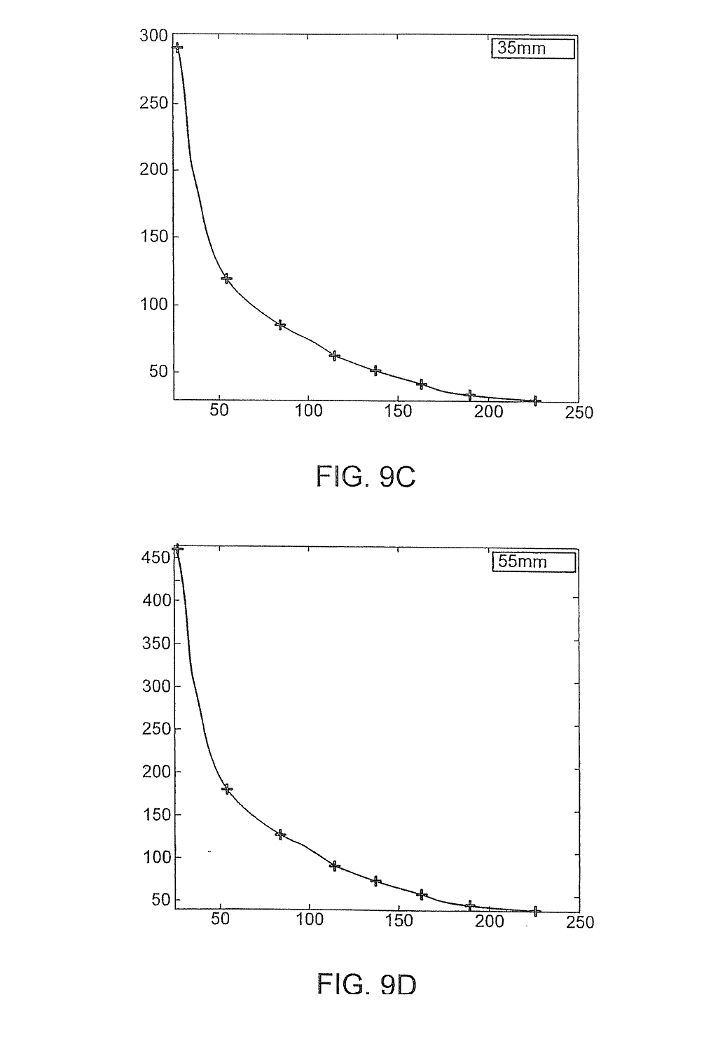

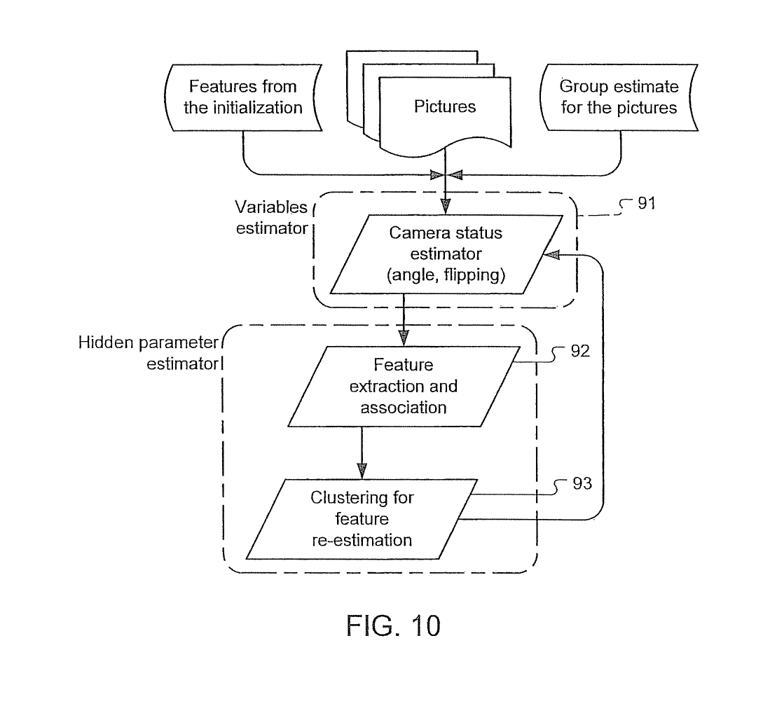

For comparison, the distances must be converted to a common metric at step 64. In the exemplary embodiment, distances between objects as provided in the map are converted to a number of pixels. To do so, we experimentally measured the behavior of the camera at different focal length values. A target of known dimension is placed at known distances from the focus plane of the camera and several pictures of the target are taken with the camera. For each distance, a ratio between the dimension in pixels inside the image and the actual size in centimeters of the target is computed. This led to several results for computing a model for the camera. For each focal length, a function is derived that best fits the experimental data. Exemplary functions are shown in FIGS. 9A-9D. By knowing these equations, we can know how many pixels an object of dimension d will take inside its picture assuming to know its distance from the camera. Performing those operations we approximated s model of the camera

When we take a picture of a scene, each point in the reality is projected on the film (the CCD in this case). The projection is not linear since the lense introduce little but evident distortions. We approximated this projection as if it was linear. In addition, the projection depends on the orientation of the camera and we instead considered as if each pair of points was always in the center of the scene.

We project all the members of the group on the circle given by the camera and the closest node within the group. For each pair of projected points, their inter-distances are computed, in order, from a side of the picture to the other (as in a chain), and we convert those values in pixels (according to the equations estimated before). What we obtain is a vector of interdistances between points that we are going to compare with the distances computed directly on the image. These distances are only approximation of the actual ones on the picture and may introduce some ambiguity into the process.

If two or more features are detected, then we can have a clue as to which feature can be associated with who. Obviously even in this case a miss can occur from the feature detector. What we supposed to do in this case is to take all the possible combinations [symbol] (i,n) of nodes within a group. For each combination of nodes c we compute the dissimilarity of their inter-distances compared with the ones computed from the extracted features; the combination having the lowest dissimilarity is chosen as representative of that group.

Each group dissimilarity measure is done with a simple 1-norm computation. For each group g_{i,n} (remember that we do not take into account the flipping with our notation) we compute its dissimilarity by choosing the combination cε [symbol] (i,n) which satisfies the following statement:

$${δ}_{i , n} = {argmin}_{c ∈ C ( i , n )} ( {\sum }_{c} \vert {d}_{{P}_{i}} - {d}_{{g}_{i , n , c}} \vert )$$

δ_{i,n} being the dissimilarity measure for the group g_{i,n}. We find an estimate of the group in the photo by using the equation set forth above for all g_{i,n}εPᵢ and by choosing the group which has the lowest dissimilarity within all the groups. The group having the lowest dissimilarity may be used to identify the objects in the image. If a miss occurred, we can recover that miss by looking at the information provided by the map. In some applications, the objects in the image may be positively identified in this manner. In other applications, ambiguities may remain in the identities of the objects.

By re-estimating the identity and position of the objects using data collected over a series of related images, we can resolve any ambiguities. In the initialization phase, we gathered for each person in the scene a set of features that can or cannot represent the actual value of the feature. To obtain a good estimate of the features, we clustered their autocorrelogram (or histogram) similarity measures in order to obtain, among all the gathered features only the more likely of being the right ones. However, for a good estimate of the features, we need to know the right status of the camera in relation to the map. On the other hand, to estimate the camera orientation, we need good features to be found in the image. This is a typical case where the variables to be estimated (the angle and the flipping) depends on hidden parameters (the features extracted from the pictures). This problem led us to consider an Expectation Maximization formulation of the solution to the problem.

The Expectation Maximization algorithm is one of the most powerful techniques used in the field of statistics to finding the maximum likelihood estimate of variables in probabilistic models. For a given random vector X we wish to find a parameter θ such that the P(X|θ) is maximum. This is known as Maximum Likelihood (ML) estimate for θ. It is typical to introduce the log likelihood (ML) estimate for θ. It is typical to introduce the log likelihood function as:

L(θ)=1n(P(X|θ))

since 1n is a strictly increasing function the value of θ that maximize P(X|θ) maximize also the L(θ) function.

The EM algorithm is an iterative procedure that increases the likelihood function at each step, until it reaches a local maximum that usually is a good estimation for the values we want for the variables. At each step we estimate a new θₙ value such that

L(θₙ)>L(θₙ₋₁)

that is to say we want to maximize their difference. We did not consider any non observable data until now. The EM algorithm provides a natural managing tool in case of presence of such hidden parameters that can be introduced at this step. Let indicate z as our hidden parameters, we can write:

$$P ( X \vert θ ) = {\sum }_{z} P ( X \vert z , θ ) P ( z \vert θ )$$

The next step will be the reformulation of the l(θₙ|θₙ₋₁) that is the expected value of the joint log-likelihood in a generic parameter set with respect of the hidden variables, given the observations and the current set:

$$l ( {θ}_{n} \vert {θ}_{n - 1} ) = {\sum }_{z} P ( X , z \vert {θ}_{n} ) P ( z \vert X , {θ}_{n - 1} )$$

This is a function only of the generic parameter θₙ.

Let's consider also the following theorem as an intermediate step in the formulation of the algorithm. We can write:

$${\sum }_{z} P ( X , z \vert {θ}_{n} ) P ( z \vert X , {θ}_{n - 1} ) \geq {\sum }_{z} P ( X , z \vert {θ}_{n - 1} ) P ( z \vert X , {θ}_{n - 1} ) \\ ⇒ P ( X \vert {θ}_{n} ) \geq P ( X \vert {θ}_{n - 1} )$$

that is to say, if the θₙ value is such that the value of l(θₙ|θₙ₋₁) is greater than the one of l(θₙ₋₁|θₙ₋₁) then the likelihood L(X|θₙ) is greater than L(X|θₙ₋₁), which was the result we wanted.

To obtain the best approximation, the parameter θₙ₋₁ is usually chosen maximizing:

$${θ}_{n + 1} = arg {max}_{θ} ( l ( θ \vert {θ}_{n - 1} ) )$$

If this maximization is not feasible, one can choose to use one of the generalized versions of the algorithm that simply choose not the best θ approximation possible but just a better one. The convergence to the local maximum is still guaranteed since the likelihood increases at each step.

FIG. 9 depicts an example of an expectation maximization algorithm, where the initialization phase is used for computing the starting values for the hidden parameters. The variables are estimated according to those values. Hence hidden parameters are re-estimated trying to maximize the likelihood function. The process continues cycling over these two steps until convergence.

For each photo in the album, we will have a corresponding list of possible groups; these groups are extracted using the techniques discussed above. We take for each group its actual node inter-distances converted into pixels and, fixed a grid structure on the image, we extract the sub areas of the image pointed by such a structure. Detected features can be used as a guide for searching.

After extracting such areas of the image, we take the information about all the possible groups that could be inside the photo, flipped or not. For each possibility we compute then its likelihood of being inside the picture. By recalling the notation given above we can write the following:

$$P ( {g}_{i , n} \vert {P}_{i} ) = a [ 1 - \frac{{δ}_{i , n}}{{\sum }_{n} {δ}_{i , n}} ] + ( 1 - α ) [ 1 - \frac{{φ}_{i , n}}{{\sum }_{n} {φ}_{i , n}} ] .$$

The α parameter was added so that for each cycle of the EM algorithm is decreased (up to 0) giving during the time a more important weight to the probability computation given by the features. The φ_{i,n} being a sort of dissimilarity measure between the features given by the database of features we built during the initialization phase and the ones just extracted from the image. We do this for all the groups that are likely to be present in the photo. Once we did this computation, we take the group with the highest probability as the right one, this gives us an estimation of the status of the photo with the given map: the rotation of the camera and the flipping status. This step of the algorithm indicated at 91 is referred to as the variables estimator, where the variables being estimated are the rotation and the flipping status.

Next, the hidden parameters are restimated at steps 92 and 93. After the camera status approximation we take the features recently extracted from the picture and we add them respectively to each person they are related to according to our estimate. By doing this, we are proceeding with the re-estimation of the features for each of the nodes. We simply add the features and we update the clustering for all the nodes involved in modifications during this phase. We will obtain a refinement of the feature describing the node. In this case the autocorrelogram technique is the one used for describing the features and computing their dissimilarities. We use such a technique since we already saw that it is more robust than a simple histogram computation for describing textures and patterns.

All these steps are repeated over the entire album and done for all the photos. After only one execution we will have an estimation of the groups inside the pictures and their actual position within the map. Running once again the last steps means repeating the same kind of operations over all the album another time. After the computation went through the entire photo dataset we try to do the same work of before, but this time knowing that the feature for each person will be more well defined.

We did not forget that there is a possibility of having an empty picture. To understand if a photo is empty we need to threshold during the phase of the groups correlation computation. If all the groups seem to belong to the same range of probability values, without having one that is really better than the others, we will not update the features and we will consider that picture empty. We have to remember that the use of the autocorrelogram technique helps us in case we would like to have a distance measurement for each of the feature with the current picture.

We would like to underline here that the identification process is completely automatic, the two information sources are completely independent one from the other allowing us in trying to support one with the other. Another thing is the entire independence of such a system of any kind of database defined a priori. By taking advantage of the expectation maximization form of the algorithm, the database is estimated at the beginning of the process and then refined step by step by the algorithm itself.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A computer-implemented method for identifying objects in an image, comprising:
capturing an image using a camera;
generating a map that defines a spatial arrangement between objects found proximate to the camera and provides a unique identifier for each object in the map;
detecting objects in the image using feature extraction methods;
identifying the objects detected in the image using the map; and
tagging the objects detected in the image with the corresponding unique identifier for object obtained from the map.

2. The method of claim 1 further comprises computing distances between the objects based on wireless data transmissions between the objects and the camera; and constructing the map from the positional information for the objects.

3. The method of claim 1 further comprises generating the map using unique identifiers received via a wireless data transmission from the objects.

4. The method of claim 1 further comprises importing the map to the camera from a location tracking system external from the camera.

5. The method of claim 1 further comprises extracting objects from the image using feature extraction methods and determining distances between the objects from the image data.

6. The method of claim 5 wherein determining distance between objects further comprises determining a focal length at which the image was captured and determining a conversion function between pixels in the image and a distance metric used to define the spatial arrangement between objects in the map.

7. The method of claim 1 wherein identifying the objects detected in the image further comprises determining a field of view at which the image was captured and determining possible groups of objects that could fall within the field of view of the camera.

8. The method of claim 7 further comprises computing distances between objects from a corresponding image for each possible group of object and computing a dissimilarity measure between the computed object distances and the map for each possible group of objects.

9. The method of claim 7 further comprises determining possible groups of objects by transposing the field of view onto the map and rotating the field of view in relation to the map.

10. The method of claim 1 further comprises identifying the objects in the image using data collected over a series of images taken by the camera.

11. The method of claim 1 further comprises identifying the objects in the image using features extracted from other images.

12. A computer-implemented method for identifying objects in an image, comprising:
capturing a series of images of a scene using a camera;
receiving a topographical map for the scene that defines distances between objects in the scene;
determining distances between objects in the scene from a given image;
approximating identities of objects in the given image by comparing the distances between objects as determined from the given image in relation to the distances between objects from the map; and
re-estimating identities of objects in the given image using features of the objects extracted from the other images.

13. The method of claim 12 further comprises generating the topographical map at the camera based wireless data transmissions with the objects

14. The method of claim 12 further comprises importing the map to the camera from a location tracking system external from the camera.

15. The method of claim 12 further comprises receiving a series of topographical maps such that each map correlates to one of the images and represents the scene when the corresponding image was captured by the camera.

16. The method of 12 further comprises extracting features of the objects from the given image using a Haar classifier and determining distances between the objects based on the extracted features.

17. The method of claim 12 wherein determining distance between objects further comprises determining a focal length at which the image was captured and determining a conversion function between pixels in the image and a distance metric.

18. The method of claim 12 wherein determining distance between objects further comprises:
determining a field of view at which the given image was captured;
determining possible groups of objects in the given image that could fall within the field of view of the camera; and
computing distances between objects in a given image for each possible group of objects.

19. The method of claim 18 wherein approximating identities further comprises, for each possible group of objects, computing a dissimilarity measure between the distances between objects as determined from the given image and the distances provide by the map; and identifying the objects using the group having a lowest dissimilarity measure.

20. The method of claim 12 further comprises re-estimating identities of objects in the given image using features of the objects extracted from other images.

21. The method of claim 20 further comprises re-estimating identities of objects in the given image by maximizing a likelihood between features of objects extracted from the given image with features of corresponding objects from other images.

22. The method of claim 1 further comprises tagging the objects detected in the image with the corresponding unique identifier for object obtained from the map.
